(19) United States
(12) Patent Application Publication
(10) Pub. No.: US 2016/0207434 A1
(43) Pub. Date: Jul. 21, 2016

(54) VEHICLE SEAT, IN PARTICULAR MOTOR VEHICLE SEAT

(71) Applicant: Johnson Controls GmbH, Burscheid (DE)

(72) Inventors: Andreas BOLTE, Zweibrücken (DE); Martin LINGE, Bietigheim-Bissingen (DE); Ulrich BECKER, Kusel (DE); Tobias KUTSCHAL, Reutlingen (DE)

(21) Appl. No.: 14/914,155

(22) PCT Filed: Aug. 28, 2014
(86) PCT No.: PCT/EP2014/068287

§ 371 Date: Feb. 24, 2016

(30) Foreign Application Priority Data
Aug. 30, 2013 (DE) 10 2013 217 339.3
Dec. 10, 2013 (DE) 10 2013 225 478.4

(51) Int. Cl. B60N 2/64; B60N 2/20

(52) U.S. Cl. CPC B60N 2/64; B60N 2/20

(57) ABSTRACT

A vehicle seat (1), in particular a motor vehicle seat, with a seat substructure (200) which, as a supporting structure, has a seat substructure structure (210) of shell-type design, a backrest (100) which, as a supporting structure, has a backrest structure (110), and at least one fitting (10) which connects the seat substructure structure (210) to the backrest structure (110). The fitting (10) has a fitting upper part (20), fastened to the backrest structure (110), and a fitting lower part (30) fastened to the seat substructure structure (210). The fitting upper part (20), excluding additional connecting elements, is arranged in a form-fitting manner in a depression (118) in the backrest structure (110) and is connected in an integrally bonded manner to the backrest structure (110) by an adhesive (50).

### CROSS REFERENCE TO RELATED APPLICATIONS

This application is a United States National Phase Application of International Application PCT/EP2014/068287 filed Aug. 28, 2014 and claims the benefit of priority under 35 U.S.C. §119 of German Patent Applications 10 2013 217 339.3 filed Aug. 30, 2013 and 10 2013 225 478.4 filed Dec. 10, 2013, the entire contents of which are incorporated herein by reference.

### FIELD OF THE INVENTION

The invention relates to a vehicle seat, in particular a motor vehicle seat, having a seat base which has, as load-bearing structure, a seat base structure, having a backrest which has, as load-bearing structure, a backrest structure of shell type of construction, and having at least one fitting which connects the seat base structure to the backrest structure, wherein the fitting has a fitting upper part, which is fastened to the backrest structure, and a fitting lower part, which is fastened to the seat base structure.

### BACKGROUND OF THE INVENTION

WO 2004/113114 A2 has disclosed a generic vehicle seat designed as a sports seat, the backrest of which has, as a load-bearing structure, a backrest shell. For the attachment of a fitting upper part to the backrest shell, an adapter is provided between the fitting upper part and the backrest shell. The adapter is screwed to the backrest shell. To prevent the formation of cracks in the backrest shell, the latter is reinforced, in the screw connection region, with inlay parts composed of metal or hard plastic. The inlay parts are inlaid into, and pressed together with, the shell material.

DE 199 05 215 A1 has disclosed a vehicle seat having a two-shell backrest and having a fitting which connects a seat base structure to the backrest structure. A fitting upper part of the fitting is inlaid into a recessed section of a main body, made up of a rear shell and a front shell, of the backrest, and is screwed to the rear shell by way of multiple additional connecting elements in the form of screws.

EP 2 463 142 A2 discloses a fitting for a vehicle seat for inclination adjustment of a backrest relative to a seat base. For the positively locking, cohesive and/or non-positively locking arrangement and fastening of the fitting upper part to the backrest, use may be made of all fastening methods known and established on the filing date of EP 2 463 142 A2. For example, it is possible for the fitting upper part and backrest to be welded, adhesively bonded, screwed and/or riveted.

EP 0 929 412 B1 has disclosed a backrest structure having an encircling frame, wherein the frame is reinforced with a transverse element in the upper region of the backrest structure. The transverse element is held in position by way of suitable means such as holding screws, welded connections or a highly loadable synthetic resin bond. The backrest structure can be fastened by way of two fittings, referred to as couplings, to a seat base structure. The fitting upper parts are connected by way of fastening means to the backrest structure.

### SUMMARY OF THE INVENTION

The invention is based on the problem of improving a vehicle seat, in particular a connection between a backrest structure and a fitting upper part with regard to strength and costs. Furthermore, the connection should permit the use of a backrest shell, composed in particular of a lightweight structural material, as backrest structure, without the need for said backrest shell to be reinforced by way of additional parts, such as for example inlay parts or other reinforcement parts, in the region of attachment to the fitting upper part. In particular, the number of components of the vehicle seat should be kept low.

This problem is solved according to the invention by way of a vehicle seat, in particular a motor vehicle seat, having a seat base which has, as load-bearing structure, a seat base structure, having a backrest which has, as load-bearing structure, a backrest structure of shell type of construction (shell construction), and having at least one fitting which connects the seat base structure to the backrest structure, wherein the fitting has a fitting upper part, which is fastened to the backrest structure, and a fitting lower part, which is fastened to the seat base structure, wherein the fitting upper part is arranged, with omission of additional connecting elements, in positively locking fashion in a depression of the backrest structure and is connected cohesively to the backrest structure by way of an adhesive.

By virtue of the fact that the fitting upper part is arranged in positively locking fashion in a depression of the backrest structure and is connected cohesively to the backrest structure by way of an adhesive, it is possible to dispense with a screw connection for the transmission of torques and forces between the fitting upper part and the backrest structure. In this context, “positively locking” means that at least a relative rotation between the fitting upper part and the backrest structure about an axis running in the transverse direction, in particular the backrest axis, is prevented. Owing to the positively locking connection, individual contours of the fitting upper part stand in the way of individual contours of the backrest structure with regard to such a rotation. The resulting blocking of the rotational movement is provided in at least one direction of rotation, preferably in both possible directions of rotation. The positive locking is realized directly by way of the contours of fitting upper part and backrest structure. It is thus possible to dispense with additional connecting elements such as pins, rivets or screws. The strength of the positively locking connection is increased by way of an additional cohesive connection by way of the adhesive. Forces in the transverse direction are accommodated in particular by the adhesive connection.

The adhesive is preferably arranged in a joining surface between the fitting upper part and the backrest structure. The adhesive may be arranged between the fitting upper part and the depression in the backrest structure. The adhesive may be arranged in the depression in the backrest structure.

“With omission of additional connecting elements” is to be understood to mean that the positive locking and the adhesive connection adequately secure the arrangement between the fitting upper part and the backrest structure so as to prevent relative displacement in all spatial directions, without further components being provided for this purpose. In the prior art, additional connecting elements, such as for example screws, are used for securing against a relative displacement in all spatial directions. By virtue of the fact that no additional connecting elements are used, the backrest structure does not have to be reinforced by way of additional parts, such as for example inlay parts or other reinforcement parts, in the region of attachment to the fitting upper part. The number of components of the vehicle seat can be kept low.

The positively locking attachment of the fitting upper part makes it possible for load to be introduced into backrest structures of shell type of construction (shell construction) over a large area. A shell type of construction (shell construction) is to be understood to mean an areal and curved type of construction with locally only little profiling, which may however by all means also have openings in individual regions. By contrast to such a shell type of construction, backrest frames of frame type of construction, for example backrest frames welded from individual sheet-steel profiles, have a highly profiled frame structure.

For weight minimization, the backrest structure is of lightweight type of construction, formed in particular from a lightweight structural material. Metallic lightweight structural materials are for example aluminum, magnesium, high-strength steels and titanium. Furthermore, fiber composite materials are also classic lightweight structural materials.

The backrest structure may be formed, in a particularly weight-optimized manner, as a carbon shell, in particular as a unipartite carbon shell. Backrest structures which are formed as a unipartite shell are particularly lightweight and require only little structural space. The weight advantages of the carbon hybrid material can be optimally utilized by way of the positively locking attachment, because it is possible to dispense with heavy inlay parts with screw attachment points for the fitting upper parts.

The depression for receiving the fitting upper part is preferably formed in a side part of the backrest structure. A side part is to be understood to mean regions of the backrest structure that are oriented substantially in a longitudinal direction. In particular in the case of a single-shell type of construction, the side part or the side parts is or are formed integrally on the shell. Alternatively, the depression may however also be provided in other regions of the backrest structure, for example in end regions of a crossmember. In this case, the depression is advantageously recessed in a transverse direction relative to immediately adjacent regions of the side part. The positive locking is thereby capable, to the greatest possible extent, of accommodating moments about an axis running in the transverse direction.

In particular, for a high-strength adhesive connection between the backrest structure and the fitting upper part, it is advantageous for the depression to run substantially areally and/or perpendicular to a backrest pivot axis which runs in a transverse direction, and/or for the backrest pivot axis to run in particular approximately through the center of area of the recessed surface.

To enlarge the adhesive surface between a flange of the fitting upper part and edge regions of the depression, it is advantageous for a width of the depression as measured in a longitudinal direction of the vehicle seat, and thus also the width of the fitting upper part as measured in the longitudinal direction, to decrease in stepped fashion from bottom to top in a vertical direction. By way of the stepped edge region, the maximum torque that can be transmitted between the fitting upper part and the backrest structure is furthermore increased. The number of steps is particularly advantageously at least two. The flange is preferably oriented in the transverse direction and in the direction of the seat center of the vehicle seat. A flange of said type furthermore increases the stiffness of the fitting upper part and can be easily accommodated in the depression.

The backrest can be used as an identical part for seat bases of different widths. The width compensation is realized by way of different fitting upper parts of a modular set, which in particular have flanges of mutually different width.

The solution according to the invention offers further advantages for vehicle seats with backrest structures composed of a plastic or of a fiber-reinforced plastic, because there are no known welded connections suitable for a connection between a metallic fitting upper part and a backrest structure composed of plastic.

It is preferable for the backrest structure to be designed as a load-bearing backrest structure, and for at least the rear side of the load-bearing backrest structure to be covered by a design shell. In this way, it is possible in particular for a backrest structure of shell type of construction to be constructed in an optimized manner in terms of weight and comfort, without consideration being given to the external appearance of the vehicle seat. The external appearance of the vehicle seat is defined by the design shell. The shaping of the load-bearing backrest structure is thus substantially independent of the external appearance, which is to be realized, of the backrest. The backrest structure may furthermore be used as an identical part in different backrests of different design. A change in design of the vehicle seat at short notice is possible by modifying the design shell, without the need to modify the safety-relevant, load-bearing backrest structure. Furthermore, the appearance of the design shell may be varied by way of paint, printing or the use of colored films, without the risk of the crash characteristics of the vehicle seat being influenced, for example by chemical reaction between load-bearing structures and paint.

The expression “load-bearing backrest structure” is to be understood in this case to mean a backrest structure which, owing to its strength and stiffness, can accommodate a major part of the forces acting on the backrest under the action of load, for example during a crash.

The design shell covers at least the rear side of the backrest structure, that is to say the side averted from the back of an occupant, though may also conceal lateral subregions, for example in the region of seat side bolsters that support the body of the occupant during cornering maneuvers. In particular, the regions of attachment of the fitting upper part to the backrest structure are concealed by the design shell.

The combination of a backrest structure with a design shell permits a high level of integration of functions into the backrest structure without adversely affecting the design, and thus permits a reduction in the number of components.

A further weight reduction can be achieved through the use of a so-called lightweight foam as a foam part.

The backrest according to the invention may be used particularly advantageously for sports seats, though is not restricted to use in sports seats. The vehicle seat according to the invention may also be a standard seat for mass-produced vehicles.

By means of the fastening according to the invention of the fitting upper part to the backrest structure, the complexity and assembly time of the vehicle seat are reduced.

The invention will be discussed in more detail below on the basis of an advantageous exemplary embodiment illustrated in the figures. The invention is however not restricted to said exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 is a schematic illustration of a vehicle seat;

FIG. 2 is an exploded illustration of the exemplary embodiment;

FIG. 3 is a perspective view of the front side of a backrest structure of the backrest of the exemplary embodiment;

FIG. 4 is a front view of the backrest structure from FIG. 3;

FIG. 5 is a side view of the backrest structure from FIG. 3;

FIG. 6 is a rear view of the backrest structure from FIG. 3;

FIG. 7 is a perspective view of an SAE H-point manikin positioned in the structure of the vehicle seat, with the design shell not illustrated;

FIG. 8 is a further perspective view, similar to FIG. 7, of an SAE H-point manikin positioned in the structure of the vehicle seat;

FIG. 9 is a detail view from the side view of FIG. 5;

FIG. 10 is a section along the line X-X in FIG. 9;

FIG. 11 is a detail view from a plan view of the backrest structure from FIG. 3; and

FIG. 12 is a sectional view along the line XII-XII in FIG. 11.

### DESCRIPTION OF THE PREFERRED EMBODIMENTS

A vehicle seat 1, which in the present case is in the form of a sports seat, for a motor vehicle has a backrest 100 and a seat base 200. The backrest 100 and the seat base 200 are connected to one another by way of two fittings 10 such as are known per se. For this purpose, each of the two fittings 10 has a fitting upper part 20, which is connected to a backrest structure 110 of the backrest 100, and a fitting lower part 30, which is connected to a seat base structure 210 of the seat base 200. The fitting upper part 20 and the fitting lower part 30 are adjustable relative to one another by way of a fitting mechanism such as is known per se, such that the inclination of the backrest 100 can be adjusted about a backrest pivot axis A. A corresponding geared fitting is known for example from DE 10 2010 035 377 A1.

In a modification of the exemplary embodiment, the backrest 100 is attached directly to the vehicle body by way of the two fittings 10. The seat base structure is then integrated into the vehicle body such that sub-regions of the vehicle body perform the function of the seat base structure 210, for example the support of the seat base, in particular of a seat cushion.

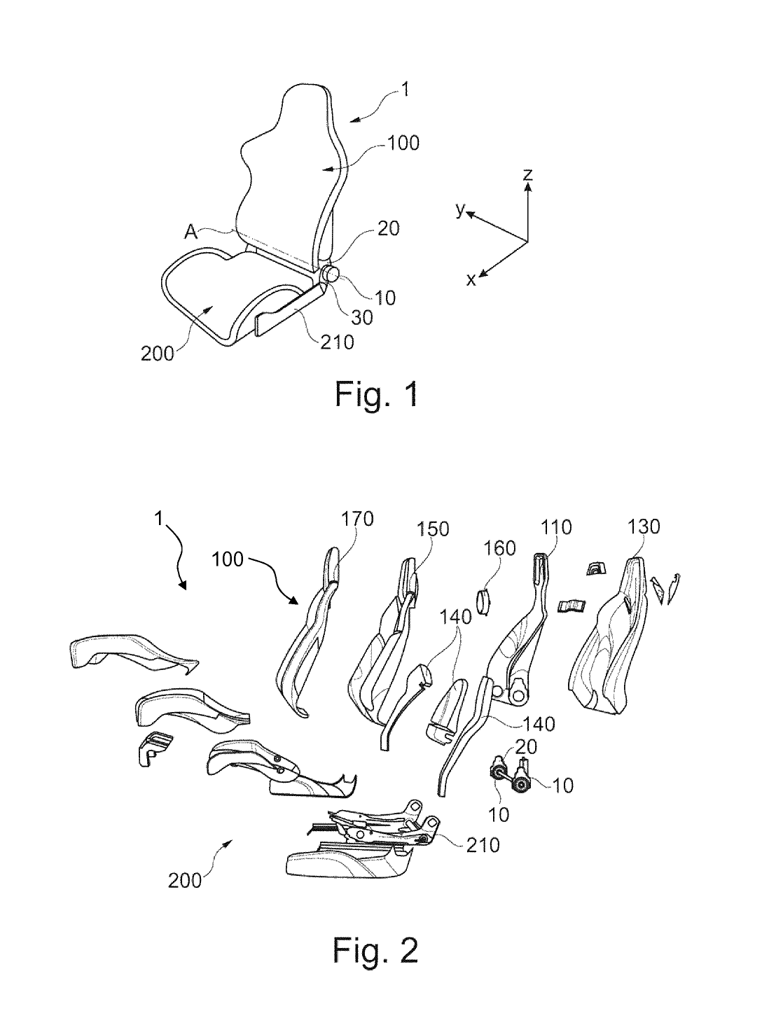

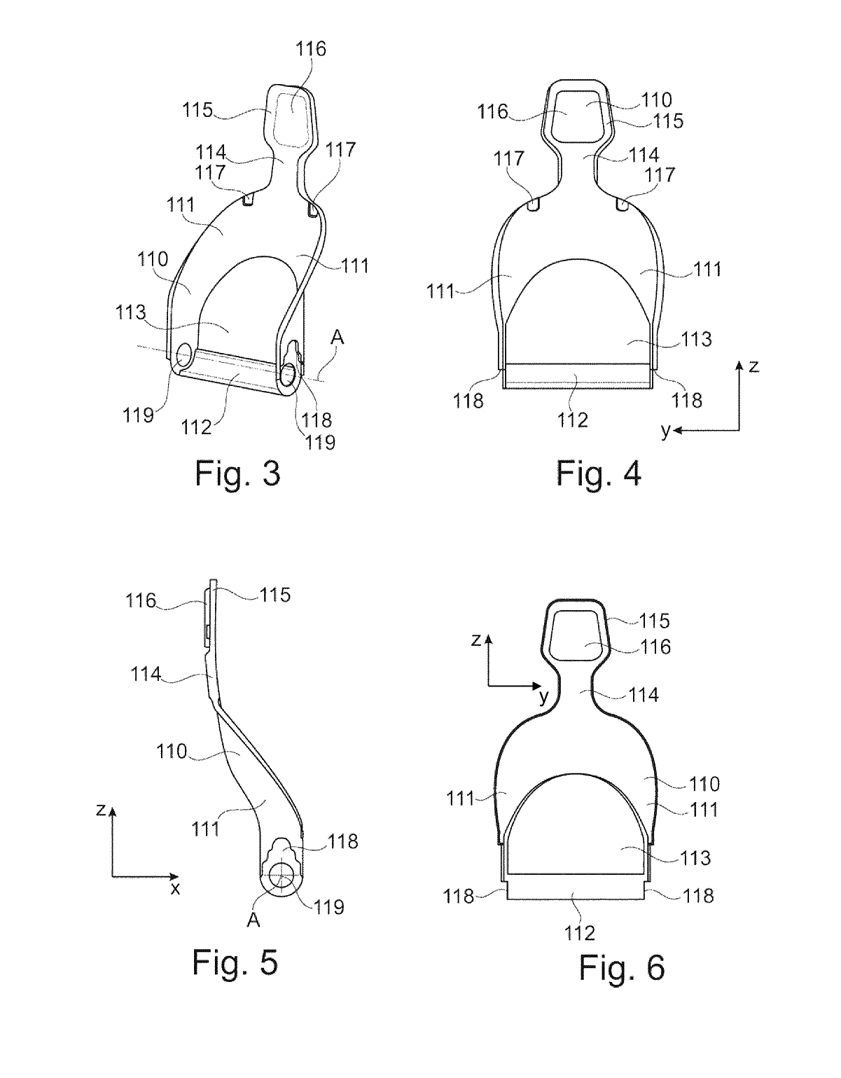

The vehicle seat 1 schematically illustrated in FIG. 1 will be described below using three mutually perpendicular spatial directions. In the case of a vehicle seat 1 installed in the vehicle, a longitudinal direction x runs substantially horizontally and preferably parallel to a vehicle longitudinal direction, which corresponds to the normal direction of travel of the vehicle. A transverse direction y, which runs perpendicular to the longitudinal direction x, is likewise oriented horizontally in the vehicle, and runs parallel to a vehicle transverse direction. A vertical direction z runs perpendicular to the longitudinal direction x and perpendicular to the transverse direction y. In the case of a vehicle seat 1 installed in the vehicle, the vertical direction z runs parallel to the vehicle vertical axis.

The position and direction statements used, such as for example front, rear, top and bottom, relate to a viewing direction of an occupant seated in the vehicle seat 1 in a normal seating position, wherein the vehicle seat 1 is installed in the vehicle, in a usage position suitable for passenger transport, with an upright backrest 100 and so as to be oriented, in the conventional manner, in the direction of travel. The vehicle seat 1 according to the invention may however also be installed in a different orientation, for example transversely with respect to the direction of travel.

The backrest 100 comprises the backrest structure 110, the rear side of which is concealed by a design shell 130. Multiple inlay parts 140 are arranged on the front side of the backrest structure 110. The front side of the backrest structure 110 and the inlay parts 140 are at least substantially concealed by a foam part 150. The foam part 150 is covered by a lining 170, the outer contours of which are fastened to the design shell 130, such that the lining 170 and the design shell 130, between them, receive the backrest structure 110, the inlay parts 140 and the foam part 150. It is optionally additionally possible for a headrest module 160, in particular for an active adjustment of the headrest position in the event of a crash, to be fastened to the backrest structure 110.

The backrest structure 110 is a load-bearing structural part of the vehicle seat 1. The forces, in particular crash forces, acting on the backrest 100 are substantially accommodated by the backrest structure 110 and transmitted via the fittings 10 into the seat base structure 210.

The backrest structure 110 is in the present case manufactured from carbon fiber-reinforced plastic as a so-called carbon shell. Alternatively, however, the structure may also be composed of a high-strength plastic, some other fiber composite material, or sheet metal, or may be formed as a metal injection molded part. In the present case, the backrest structure 110 is of unipartite form, though may alternatively also be assembled from multiple individual parts.

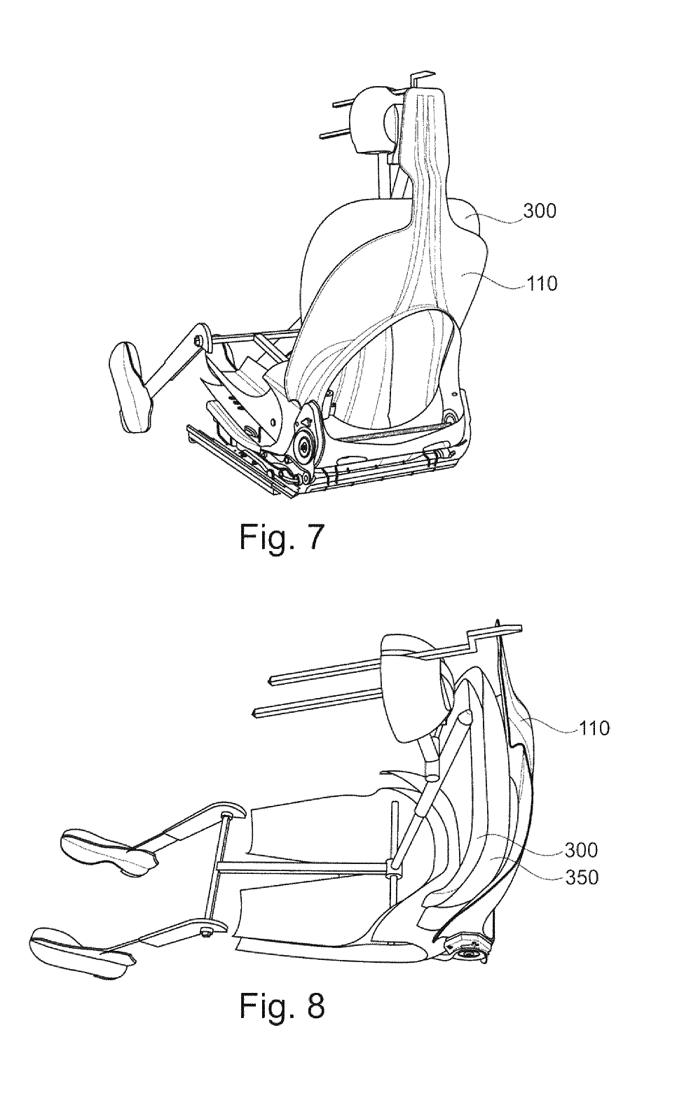

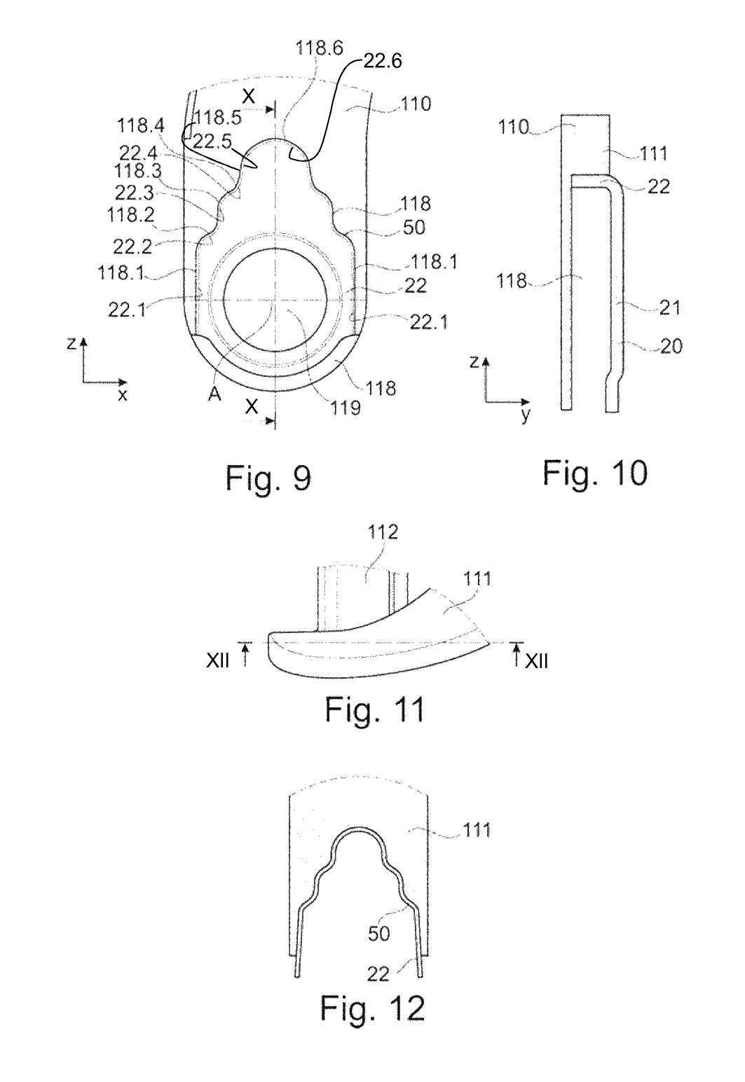

As illustrated in FIGS. 7 and 8, the backrest structure 110 is ergonomically shaped such that the spacing between the backrest structure 110 and an SAE H-point manikin 300 (conforming to SAE standard J826) positioned correctly in the vehicle seat 1, in particular the bowl-like buttocks and back parts of said manikin, is substantially equidistant. In the back region in particular, that surface of the backrest structure 110 which is oriented toward the occupant substantially corresponds to an equidistant surface 350 which runs so as to be spaced apart by 30 mm from the back part of the SAE H-point manikin 300. The structural space resulting from said spacing is, in the case of a fully cushioned vehicle seat 1, filled by the inlay parts 140, the foam part 150 and the lining 170.

The design shell 130 and the lining 170 define the exterior design of the backrest 100 without contributing significantly to the strength of the backrest 100. The design shell 130 is in the present case in the form of an injection-molded part composed of a plastic known per se. The lining 170 is preferably composed substantially of fabric and/or leather.

The inlay parts 140 are produced preferably from expanded polypropylene (EPP) and serve for the fastening of further components (not illustrated in the Figures) within the backrest 100. Further components are for example lumbar supports, electric drives or side bolster adjustment mechanisms, such as are known per se. The inlay parts 140 contribute only insignificantly to the strength of the backrest 100.

In the present case, the foam part 150 is composed of a polyurethane soft foam and serves substantially for seating comfort, without contributing significantly to the strength of the backrest 100.

The backrest structure 110 is substantially mirror-symmetrical with respect to a plane which runs, parallel to the longitudinal direction x and parallel to the vertical direction z, through the seat center.

The backrest structure 110 comprises, in the two outer regions as viewed in the transverse direction y, a side part 111 of substantially areal form. Proceeding in the vertical direction z from a lower region which is arranged around the backrest pivot axis A and which is oriented perpendicular to the backrest pivot axis A, the two side parts 111 run upward so as to be increasingly curved and turned toward the seat center, and merge into one another there. In the lower region of the backrest structure 110, the two side parts 111 are connected to one another by way of a crossmember 112 running in the transverse direction y. The two side parts 111 and the crossmember 112 form, between them, a first opening 113.

Proceeding from the region of the backrest structure in which the two side parts 111 merge into one another, a web 114 runs upward in the region of the seat center and ends in a trapezoidal headrest support 115. The headrest support 115 has a headrest receptacle 116 in the form of a depression.

In each case one fastening point 117 in the upper region of each side part 111 serves for the fastening of the design shell 130, which is hooked onto the backrest structure 110 there from above, for example by way of in each case one integrally molded tongue-like lug.

Each of the two side parts 111 has, in its lower region, a depression 118 in the transverse direction y for receiving the fitting upper part 20 in positively locking fashion.

Like the rest of the side part 111 in its lower region, the depression 118 runs substantially areally and perpendicular to the backrest pivot axis A. In the middle of the depression 118 there is situated a circular second opening 119, the central point of which lies on the backrest pivot axis A.

In the present case, the depression 118 is mirror-symmetrical with respect to a plane of symmetry which encompasses the backrest pivot axis A and which runs approximately in the vertical direction z. The spacing between the border of one half of the depression 118 and the plane of symmetry varies in the vertical direction z, and defines the width of the depression 118.

The depth of the depression 118 in relation to the adjacent region of the side part 111 is constant. The width of the depression 118 decreases in stepped fashion from bottom to top in the vertical direction z, wherein the steps are of rounded form. The outer delimitation of the depression 118 with respect to the adjacent region of the side part 111 is formed by an edge region. The depression 118 is not bordered in the downward direction.

At the height of the backrest pivot axis A, the width of the depression 118, between two first edge regions 118.1 which run linearly and approximately parallel to one another, is at its greatest. Each first edge region 118.1 is adjoined in the upward direction by in each case one second edge region 118.2. The two second edge regions 118.2 form in each case one rounded step between the two first edge regions 118.1 and two third edge regions 118.3, which run linearly and approximately parallel to one another. Each third edge region 118.3 is adjoined in the upward direction by in each case one fourth edge region 118.4. The two fourth edge regions 118.4 form in each case one rounded step between the two third edge regions 118.3 and two fifth edge regions 118.5 which run linearly and approximately parallel to one another. At the two upper ends of the two fifth edge regions 118.5, the two fifth edge regions 118.5 are connected to one another by a semicircular curved sixth edge region 118.6.

The two fifth edge regions 118.5 are of shorter form than the two first and third edge regions 118.1, 118.3 and, in a modification of the exemplary embodiment, are omitted entirely, such that the two fourth edge regions 118.4 in this case transition directly into the sixth edge region 118.6.

The edge regions 118.1, 118.3 and 118.5, which run in each case approximately parallel to one another, preferably converge on one another slightly in the upward direction, in a slight deviation from parallelism, such that in the approximately parallel regions, the depression 118 also tapers conically slightly in the upward direction. The expression “approximately parallel” is therefore intended to encompass both mathematically exact parallelism and also angular deviations of up to 5°.

The depth of the edge regions 118.1 to 118.6 in the transverse direction y defines the depth of the depression 118.

In the present case, the second fitting upper part 20 is manufactured from sheet steel and has a main body 21 which runs substantially parallel to the longitudinal direction x and to the vertical direction z. The outer contour of the main body 21 has a flange 22 which is oriented perpendicular to the main body 21 in the transverse direction y and in the direction of the seat center. The flange 22 is divided into multiple regions which are in each case of complementary form with respect to the edge regions 118.1 to 118.6 of the depression 118, such that the depression 118 receives the flange 22 within it in positively locking fashion. In the present case, in each case two first flange regions 22.1 bear against the two first edge regions 118.1, two second flange regions 22.2 bear against the two second edge regions 118.2, two third flange regions 22.3 bear against the two third edge regions 118.3, two fourth flange regions 22.4 bear against the two fourth edge regions 118.4, two fifth flange regions 22.5 bear against the two fifth edge regions 118.5, and a sixth flange region 22.6 bears against the sixth edge region 118.6, possibly with the interposition of an adhesive 50.

In a modification of the exemplary embodiment, for the compensation of manufacturing tolerances, only some of the flange regions 22.1 to 22.6 bear against the associated edge regions 118.1 to 118.6. In some cases, the flange regions 22.1 to 22.6 are spaced apart slightly from the associated edge regions 118.1 to 118.6.

In the present case, the flange 22 and thus the fitting upper part 20 are additionally adhesively bonded to the backrest structure 110. For this purpose, a thin layer of the adhesive 50 is provided between the flange regions 22.1 to 22.6 and the edge regions 118.1 to 118.6 which bear against one another.

The features disclosed in the above description, in the claims and in the drawings may be of importance both individually and in combination for the realization of the invention in its various refinements.

While specific embodiments of the invention have been shown and described in detail to illustrate the application of the principles of the invention, it will be understood that the invention may be embodied otherwise without departing from such principles.

1. A motor vehicle seat comprising:
a seat base which has, as load-bearing structure, a seat base structure;
a backrest which has, as load-bearing structure, a backrest structure of a shell construction; and
at least one fitting which connects the seat base structure to the backrest structure, wherein the fitting has a fitting upper part, which is fastened to the backrest structure, and a fitting lower part, which is fastened to the seat base structure and the fitting upper part is arranged, with omission of additional connecting elements, in a positively locking connection in a depression of the backrest structure and is connected cohesively to the backrest structure by way of an adhesive and the fitting upper part has a flange oriented in a transverse direction (y) and in a direction of a seat center of the vehicle seat, and the flange of the fitting upper part with a positively locking connection in the depression.

2. The vehicle seat as claimed in claim 1, wherein the backrest structure is of lightweight construction.

3. The vehicle seat as claimed in claim 1, wherein the backrest structure is formed from a lightweight structural material.

4. The vehicle seat as claimed in claim 1, wherein the backrest structure is formed from a plastic.

5. The vehicle seat as claimed in claim 1, wherein the backrest structure is in the form of a unipartite shell.

6. The vehicle seat as claimed in claim 1, wherein the backrest structure is in the form of a carbon shell.

7. The vehicle seat as claimed in claim 1, wherein the depression is formed in a side part of the backrest structure.

8. The vehicle seat as claimed in claim 7, wherein the depression is formed so as to be recessed in the transverse direction (y) in relation to immediately adjacent regions of the side part.

9. The vehicle seat as claimed in claim 8, wherein the depression runs substantially areally.

10. The vehicle seat as claimed in claim 9, wherein the depression runs perpendicular to a backrest pivot axis which runs in the transverse direction (y).

11. The vehicle seat as claimed in claim 1, wherein a width of the depression, as measured in a longitudinal direction (x), decreases in stepped fashion from bottom to top in a vertical direction (z) to provide a stepped contour.

12. The vehicle seat as claimed in claim 11, wherein the number of steps is at least two.

13. The vehicle seat as claimed in claim 11, wherein the outer contour of the fitting upper part is adapted to the stepped contour of the depression such that the fitting upper part is received in positively locking fashion in the depression.

14-15. (canceled)

16. The vehicle seat as claimed in claim 4, wherein the backrest structure is in the form of a unipartite shell.

17. The vehicle seat as claimed in claim 4, wherein the depression is formed in a side part of the backrest structure.

18. The vehicle seat as claimed in claim 17, wherein the depression is formed so as to be recessed in the transverse direction (y) in relation to immediately adjacent regions of the side part.

19. The vehicle seat as claimed in claim 18, wherein the depression runs substantially areally and the depression runs perpendicular to a backrest pivot axis which runs in the transverse direction (y).

20. The vehicle seat as claimed in claim 4, wherein a width of the depression, as measured in a longitudinal direction (x), decreases in steps from a bottom to a top in a vertical direction (z) to provide a stepped contour.

21. The vehicle seat as claimed in claim 20, wherein the number of steps is at least two.

22. The vehicle seat as claimed in claim 20, wherein the outer contour of the fitting upper part is adapted to the stepped contour of the depression such that the fitting upper part is received in positively locking fashion in the depression.
